(19) United States
(12) Patent Application Publication
(10) Pub. No.: US 2022/0170435 A1
(43) Pub. Date: Jun. 2, 2022

(54) FUEL INJECTOR NOZZLE

(71) Applicant: Dynomite Diesel Products, Hayden, ID (US)

(72) Inventor: Leonard Allan Reed, Hayden, ID (US)

(21) Appl. No.: 17/108,900

(22) Filed: Dec. 1, 2020

(51) Int. Cl. F02M 61/18

(52) U.S. Cl. CPC F02M 61/1826; F02M 61/1846; F02M 61/182

(57) ABSTRACT

A fuel injector nozzle includes a nozzle body having a nozzle cavity and a nozzle tip defining an end of the nozzle body. The fuel injector nozzle further includes one or more injection orifices having a first diameter, the one or more first injection orifices being located a first distance from the end of the nozzle body and connecting the nozzle cavity to a combustion chamber of an engine. The fuel injector nozzle also includes one or more second injection orifices having a second diameter that is different than the first diameter, the one or more second injection orifices being located at a second distance from the end of the nozzle body and fluidly connecting the nozzle cavity to the combustion chamber.

### BACKGROUND

The design of fuel injection systems greatly impacts the performance of combustion engines. One of the primary purposes of fuel injection systems is to deliver fuel to cylinders of a combustion engine during operation of the combustion engine. However, the manner in which a fuel injection system delivers fuel to the cylinders of the combustion engine directly impacts engine performance, noise characteristics, emissions, etc. Thus, fuel injection systems are carefully designed to inject fuel into the cylinders at a proper time during a combustion cycle. Fuel injection systems are also designed to deliver a precise amount of fuel to the cylinders of the combustion engine to meet the necessary power requirements for each cylinder of the engine.

Often times, however, fuel injection systems are required to control additional parameters to achieve adequate combustion events. For example, fuel injection systems control fuel atomization, bulk mixing, and air utilization. Fuel injection systems atomize fuel that is injected into the combustion engine during the combustion process to ensure that fuel atomizes into a fuel particle size necessary to vaporize the fuel. Fuel particles that are not atomized during the combustion process can burn poorly and are often exhausted out of the combustion engine. This can lead to increased emissions, smoke, decreased performance of the combustion engine, etc. Existing solutions for improving fuel atomization in conventional fuel systems include applying an electrostatic charge to fuel to improve atomization, introducing a magnetic field in the combustion chamber, replacing a fuel injector with an ultrasonic atomizer, among other solutions. However, these solutions often require complex systems and components that can be expensive, increase a propensity of a fuel injector (or fuel system) to fail, require increased maintenance, etc.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates a schematic view of an example combustion chamber in a combustion engine.

FIG. 2 illustrates a perspective view of an example fuel injector nozzle.

FIG. 3 is a cross-sectional view of the fuel injector nozzle taken along line A-A shown in FIG. 2.

FIG. 4 is a cross-sectional view of the fuel injector nozzle taken along line B-B shown in FIG. 2.

FIG. 5 illustrates a perspective view of an example fuel injector nozzle.

FIG. 6 is an enlarged detail view of the area marked C circumscribed in FIG. 5.

FIG. 7 is a cross-sectional view of the fuel injector nozzle taken along line D-D shown in FIG. 5.

### DETAILED DESCRIPTION

This disclosure is directed to a fuel injector nozzle (referred to herein as “an injector nozzle”) that is designed to enhance performance of a combustion cycle in a combustion engine. The injector nozzle is designed to improve atomization of fuel that is delivered to a cylinder of the combustion engine during the combustion cycle. In some examples, the combustion engine is a compression ignition diesel engine. However, the injector nozzle described herein can be used in other types of combustion engines.

The injector nozzle described herein can improve fuel particle size distribution of fuel that is injected into the cylinder of the combustion engine. For example, the injector nozzle described herein can inject fuel into the cylinder with improved variance of particle size. Typically, larger fuel particles travel further before ignition than smaller fuel particles. If fuel particles reach a piston of the combustion engine prior to ignition, the combustion of such fuel particles can cause damage to the piston or other components of the combustion engine. Furthermore, smaller fuel particles can ignite more quickly and/or more easily than a comparatively larger particle. Therefore, reducing fuel particle size can improve performance the combustion cycle and/or reduce emissions of the combustion cycle. Still further, once an exhaust valve opens in the cylinder of the combustion engine, any remaining non-ignited fuel particles can be drawn out of the cylinder, resulting in lost energy and/or increased emissions.

The injector nozzle described herein can improve particle distribution of fuel particle size by including a plurality of injection orifices having varying diameters. For example, the injector nozzle includes a nozzle body. The nozzle body further includes a nozzle cavity within the nozzle body. A nozzle tip defines an end of the nozzle body. When the injector nozzle is installed in a combustion engine as part of a fuel injector, the nozzle tip can be, at least partially, inserted into a cylinder of the combustion engine. In such an example, the plurality of injection orifices connects the nozzle cavity to the combustion chamber (i.e., the cylinder) of the combustion engine such that fuel flows through the nozzle cavity into the combustion chamber of the combustion engine.

The injector nozzle can include one or more first injection orifices having a first diameter. The one or more first injection orifices can be located at a first distance from an end (i.e., the nozzle tip) of the nozzle body. The injector nozzle can also include one or more second injection orifices having a second diameter. In some examples, the second diameter is less than the first diameter. For example, the second diameter can be approximately half of the first diameter. However, the first diameter and the second diameter can include various dimensions. Furthermore, the one or more second injection orifices can be located at a second distance from the end of the nozzle body. The second distance can be less than the first distance such that the one or more second injection orifices are closer to the end of the nozzle body than the one or more first injection orifices. In some examples, a length of the nozzle body extends in a vertical direction and individual ones of the one or more second injection orifices are offset from individual ones of the one or more first injection orifices in a horizontal direction.

By including one or more second injection orifices that are smaller than the one or more first injection orifices, the injector nozzle injects fuel particles into the cylinder at varying particle sizes. Thus, the smaller fuel particles can ignite prior to the larger fuel particles and, in some examples, can travel a shorter distance than the larger particles prior to ignition. Furthermore, by igniting the smaller fuel particles before the larger fuel particles, the ignition of the smaller fuel particles can cause ignition of the larger fuel particles. Therefore, the injector nozzle can create multiple ignition events (i.e., ignition of small fuel particles and ignition of large fuel particles) in a single in injection event. Such a design of the injector nozzle can increase performance of a combustion event and/or reduce emissions associated with the combustion event.

The injector nozzle described herein can also improve fuel injection into the cylinder by reducing and/or eliminating choked flow through the plurality of injection orifices. For example, the plurality of injection orifices includes an exterior edge on an outside surface of the nozzle body and an interior edge on an inside surface of the nozzle body. The inside surface of the nozzle body defines the nozzle cavity. In conventional fuel injector nozzles, the exterior edge and the interior edge of the injection orifices are approximately 90 degrees. Therefore, as fuel enters an injection orifice, the flow of fuel through the injection orifice can be choked through the injection orifice. The injector nozzle described herein can include a rounded (or chamfered) interior edge to reduce and/or eliminate choked flow through individual injection orifices of the plurality of injection orifices. Following the example described previously, the one or more first injection orifices and the one or more second injection orifices can include a rounded or chamfered interior edge. The interior edge can be rounded or chamfered by flowing an abrasive-laden fluid through the plurality of injection orifices in an abrasive flow machining (AFM) process.

The injector nozzle described herein can also improve fuel atomization by including a counterbored hole on an exterior surface of the nozzle body that is coaxial with individual injection orifices of the plurality of injection orifices. The plurality of injection orifices can include a first length and the counterbore holes include a second length that is less than the first length. In some examples, the plurality of injection orifices includes a first diameter and the counterbored holes include a second diameter that is greater than the first diameter. The second diameter can be approximately twice the size of the first diameter. However, a ratio between the second diameter and the first diameter can vary. In some examples, the counterbore holes include an exterior hole edge on an outside surface of the nozzle body and an interior hole edge on an inside surface of the counterbore hole. In such example, the interior hole edge is rounded. By rounding the interior hole edge, fuel is drawn out of the injection orifice quicker when compared with an interior hole edge that is a square edge. For example, by rounding the interior hole edge, the fuel can maintain laminar flow as the fuel is injected out of the injection orifices into the cylinder. Conversely, if the interior hole edge is a square edge, the fuel can experience drag in the corners and/or turbulent flow, thereby slowing fuel injection into the cylinder.

Furthermore, by including a counterbore hole that is coaxial with an injection orifice, fuel that is injected into the cylinder can disperse sooner than fuel injected through an injection orifice that does not include a counterbore hole. Therefore, the counterbore hole can improve atomization of the fuel that is injected into the cylinder. In some examples, the plurality of injection orifices can include a counterbore hole on an exterior surface of the nozzle body and a rounded or chamfered interior edge on the interior surface of the nozzle body. Furthermore, following the example described previously, the one or more first injection orifices having a first diameter can include counterbored holes on an exterior surface of the nozzle body and/or the one or more second injection orifices having a second diameter can include counterbored holes on the exterior surface of the nozzle body.

Specific examples are described herein in order to meet statutory requirements. However, the description itself is not intended to limit the scope of the claims. It is contemplated that the claims might also be implemented in other ways, to include different elements or combinations of elements similar or equivalent to what is described in this document, in conjunction with other present or future technologies.

The present disclosure provides an overall understanding of the principles of the structure, function, manufacture, and use of the apparatuses and methods described herein. One or more examples of the present disclosure are illustrated in the accompanying drawings. Those of ordinary skill in the art will understand that the apparatuses and methods specifically described herein and illustrated in the accompanying drawings are non-limiting. The features illustrated or described in connection with one example can be combined with the features of other examples, including as between apparatuses and methods. Such modifications and variations are intended to be included within the scope of the appended claims.

Additional details are described below with reference to the accompanying figures.

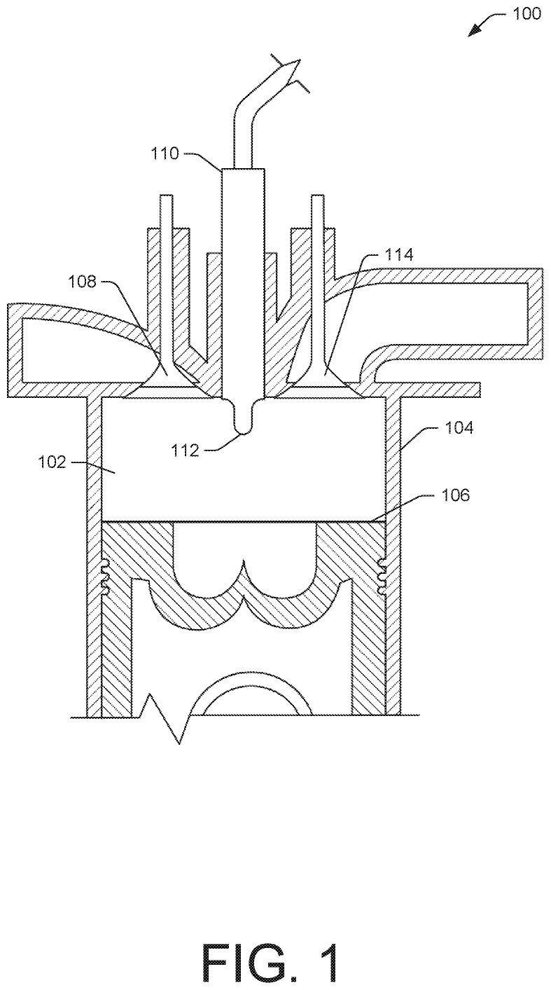

FIG. 1 illustrates an example combustion engine 100 having a combustion chamber 102. The combustion chamber 102 can be defined by a space between a cylinder 104 and a piston 106. Thus, as combustion engine 100 goes through various cycles, the combustion chamber 102 varies in size based on a stroke of the piston 106. For example, as the piston 106 strokes upward, the combustion chamber 102 decreases in volume. Conversely, when the piston 106 strokes downward, the combustion chamber 102 increases in volume. While shown as a four-stroke combustion engine, the combustion engine 100 can include any number of strokes in a combustion cycle (or “power cycle”). As shown in FIG. 1, the combustion engine 100 includes an intake valve 108. During an intake step of the combustion cycle, the intake valve 108 opens while the piston 106 draws air into the cylinder through a downward motion (or stroke). Fuel is injected into the combustion chamber 102 so that the fuel can mix with the air. As shown in FIG. 1, fuel is injected into the combustion chamber 102 by a fuel injector 112. The fuel injector 110 injects fuel through an injector nozzle 112. While FIG. 1 depicts a direct injection configuration of the combustion engine 100, fuel can be injected into the combustion chamber 102 directly or indirectly. The piston 106 then rises in a compression stroke to compress the air and fuel mixture. In a diesel combustion engine, the compression of the air and fuel mixture by the piston 106 causes ignition of the fuel. However, in a gas combustion engine, a spark plug is used to ignite the fuel during the compression stroke. Combustion of the fuel drives the piston 106 downward, thereby rotating a crankshaft. An exhaust valve 114 is then opened and the piston 106 rises in an exhaust stroke to force the exhaust out of the combustion chamber 102.

As mentioned previously, atomization of the fuel in the combustion chamber 102 directly impacts performance of the combustion engine 100. Furthermore, adequate particle size distribution is necessary to reduce emission of the combustion engine 100. Conversely, inadequate particle size distribution and/or particles that are too large can cause decreased performance, increased emissions and/or smoke, and/or damage to components of the combustion engine 100.

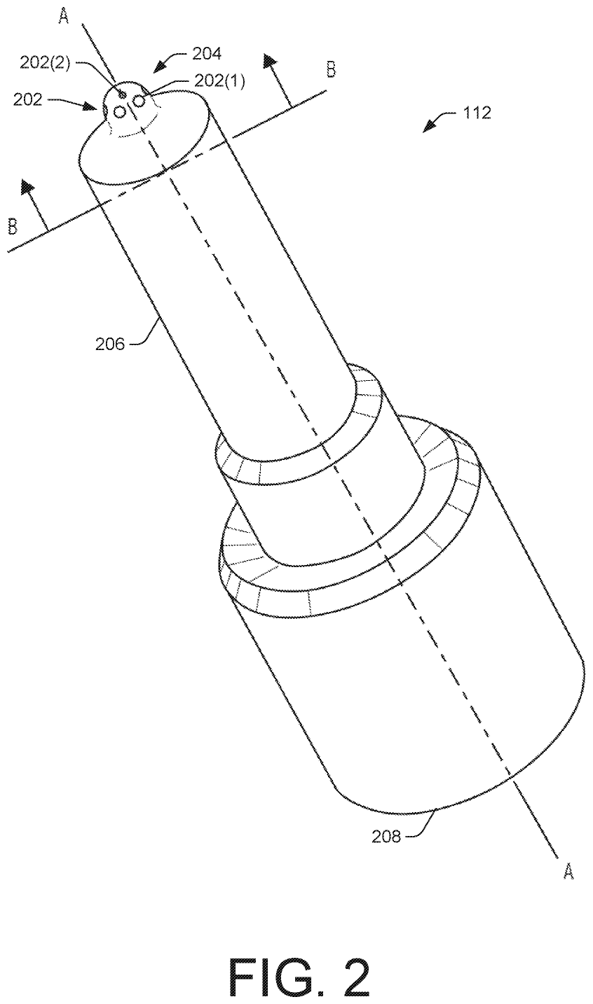

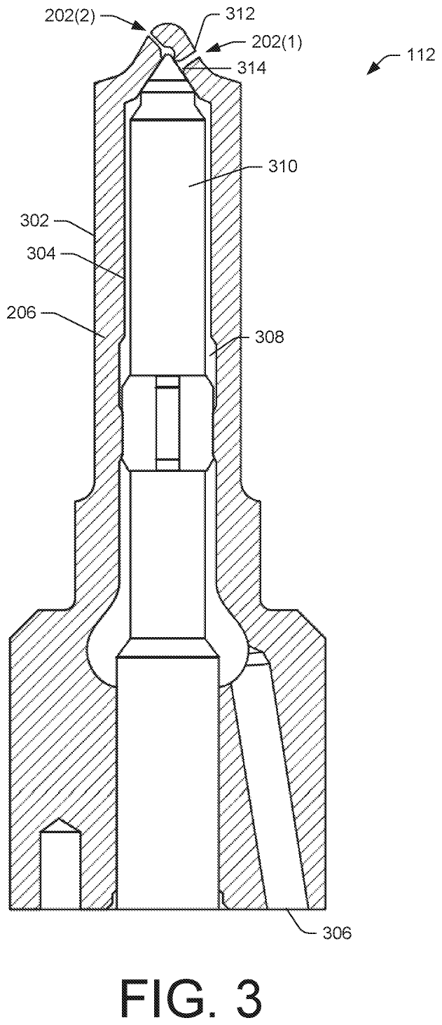

FIG. 2 illustrates a perspective view of an example fuel injector nozzle 112 (referred to herein as an “injector nozzle”). The injector nozzle 112 shown in FIG. 2 includes a plurality of injection orifices 202. The plurality of injection orifices 202 may be located on a nozzle tip 204 of a nozzle body 206. The nozzle tip 204 defines a first end of the nozzle body 206. A sealing face 208 defines a second end of the nozzle body 206 that is opposite the first end. The plurality of injection orifices 202 are machined to connect a nozzle cavity (shown and described in FIG. 3) to an environment surrounding the nozzle body 206 (e.g., the combustion chamber 102).

As shown in FIG. 2, the injector nozzle 112 can include one or more first injection orifices 202(1) having a first diameter. The one or more first injection orifices 202(1) are located at a first distance (D1) from the first end (i.e., the nozzle tip 204) of the nozzle body 206. The injector nozzle can also include one or more second injection orifices 202(2) having a second diameter. In some examples, the second diameter is approximately half of the first diameter. Additionally, and/or alternatively, the second diameter can be between approximately ¼ and approximately ¾ of the first diameter, between approximately ⅓ and approximately ⅔ of the first diameter, etc. Furthermore, the first diameter and second diameter can be designed to be any size and are not limited to the ranges described above. In some examples, the one or more second injection orifices 202(2) can be larger than the one or more first injection orifices 202(1).

In some examples, the one or more second injection orifices 202(2) are located at a second distance from the first end (i.e., the nozzle tip 204) of the nozzle body 206. The second distance can be less than the first distance such that the one or more second injection orifices 202(2) are closer to the first end of the nozzle body 206 than the one or more first injection orifices 202(1). By positioning the one or more second injection orifices 202(2) closer to the first end of the nozzle body, the injector nozzle 112 can inject smaller fuel particles lower in the combustion chamber 102 relative to larger fuel particles that are injected through the one or more first injection orifices 202(1). The smaller fuel particles injected through the one or more second injection orifices 202(2) can initiate combustion prior to larger fuel particles due to their smaller relative size. Thereby, combustion of the fuel in the combustion chamber 102 can be initiated by the smaller fuel particles injected through the one or more second injection orifices 202(2). In some examples, the smaller fuel particles can act as a pilot injection without requiring multiple injection events. However, the fuel injector 110 can be configured to inject fuel into the combustion chamber 102 multiple times during each cycle of a combustion process. In some examples, a length of the nozzle body extends in a vertical (or first) direction and the one or more second injection orifices 202(2) are offset from the one or more first injection orifices 202(1) in a horizontal (or second) direction that is perpendicular to the first direction. The profile of the nozzle body 206 can vary and is not limited to the profile of the nozzle body 206 shown in FIG. 2.

FIG. 3 is a cross-sectional view of the injector nozzle 112 taken along line A-A shown in FIG. 2. As shown in FIG. 3, the nozzle body 206 includes an exterior surface 302 and an interior surface 304. Fuel is provided to the injector nozzle 112 via the fuel inlet passage 306. The interior surface 304 of the nozzle body 206 defines a nozzle cavity 308 through which fuel is injected into a combustion chamber 102. The injector nozzle 112 includes a needle 310. The needle 310 raises in order to allow fluid to flow through the injection orifices 202. When the needle 310 is seated against the nozzle body 206 (as shown in FIG. 3), the needle 310 prevents fluid from passing through the injection orifices 202. As described above, the injector nozzle 112 includes one or more first injection orifices 202(1) that have a first diameter and one or more second injection orifices 202(2) that have a second diameter. The plurality of injection orifices 202 include an exterior edge 312 on the exterior surface 302 of the nozzle body 206 and an interior edge 314 on the interior surface 304 of the nozzle body 206. The interior edge 314 of the plurality of injection orifices 202 can be rounded or chamfered. The interior edge 314 can be rounded or chamfered by flowing an abrasive-laden fluid through the plurality of injection orifices 202 in an AFM process (e.g., extrude honing process).

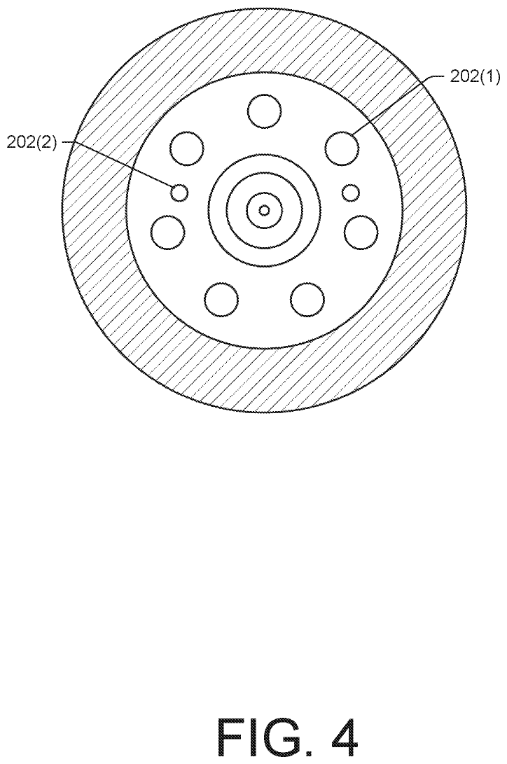

FIG. 4 is a cross-sectional view of the injector nozzle 112 taken along line B-B shown in FIG. 2 looking towards the first end of the injector nozzle 112. As shown in FIG. 4, the injector nozzle 112 includes one or more first injection orifices 202(1) having a first diameter and one or more second injection orifices 202(2) having a second diameter. In some examples, the first diameter can be greater than the second diameter. The plurality of injection orifices 202 includes a rounded or chamfered interior edge 314, as described above. The injector nozzle 112 can include any number of injection orifices 202 and/or any number of first injection orifices 202(1) and second injection orifices 202(2). For example, the injector nozzle 112 can include between two and sixteen first injection orifices 202(1) and between two and six second injection orifices 202(2). As shown in FIG. 4, the injector nozzle can include seven first injection orifices 202(1) and two second injection orifices 202(2). The injector nozzle 112 is not limited to the quantity of the plurality injection orifices 202 shown in the figures included herein.

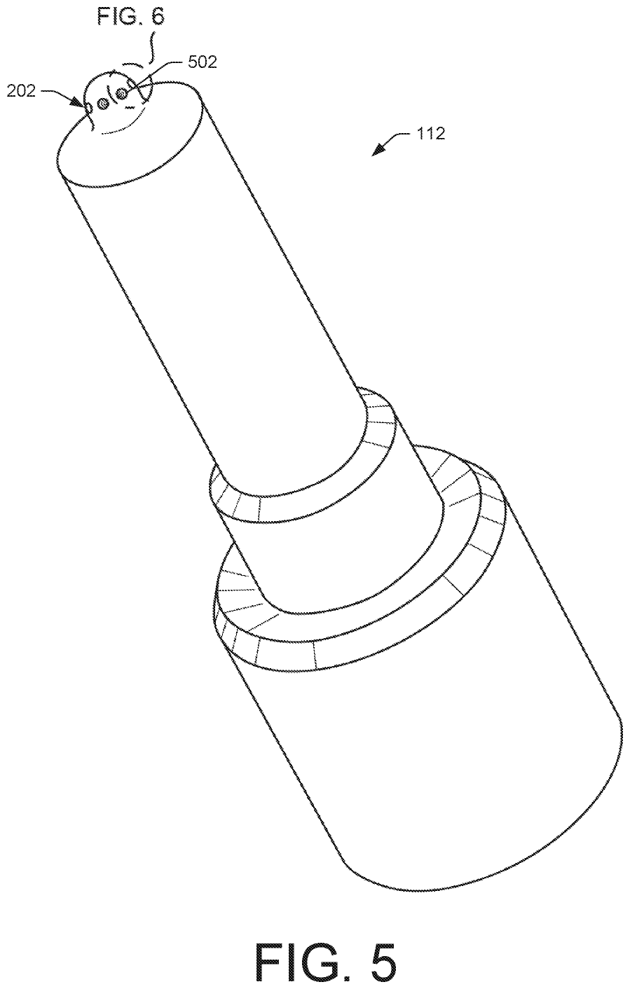

FIG. 5 illustrates a perspective view of an example fuel injector nozzle 112 (referred to herein as an “injector nozzle”). The injector nozzle 112 shown in FIGS. 5-7 can be the same as the injector nozzle 112 shown and described in FIGS. 2-4 or the injector nozzle 112 shown in FIGS. 5-7 can be different than the injector nozzle 112 shown in FIGS. 2-4. As shown in FIG. 5, the injection orifices 202 include counterbore holes 502. As shown in FIG. 5, the counterbore holes 502 are coaxial with an axis of extension of the plurality of injection orifices 202. The counterbore holes 502 can be formed by an electrical discharge machining (EDM) process. In some examples, the plurality of injection orifices 202 include a first diameter and the counterbore holes 502 include a second diameter. The second diameter can be approximately double the first diameter. However, the exact dimensions of the first diameter and second diameter can vary.

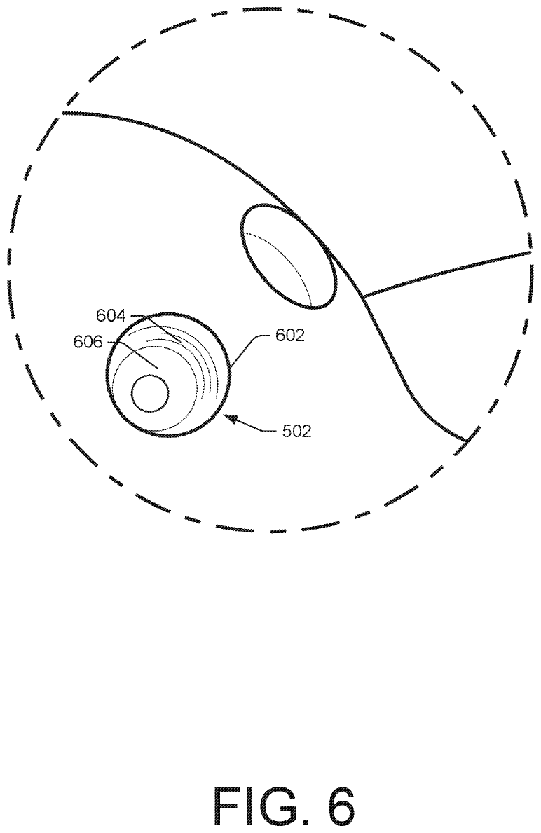

FIG. 6 is an enlarged detail view of the area marked “FIG. 6” circumscribed in FIG. 5. FIG. 6 depicts a counterbore hole 502 having an exterior hole edge 602 on an exterior surface 302 of the nozzle body 206 and an interior hole edge 604 on an inside surface 606 of the counterbore hole 502. As shown in FIG. 6, the interior hole edge 604 is rounded. By rounding the interior hole edge 604, fuel is drawn out of an injection orifice quicker when compared with an interior hole edge that is a square edge. For example, by rounding the interior hole edge, the fuel can maintain laminar flow as the fuel is injected out of the injection orifices into the cylinder 104. Conversely, if the interior hole edge is a square edge, the fuel can experience drag in the corners and/or turbulent flow, thereby slowing fuel injection into the cylinder 104.

In some examples, the plurality of injection orifices 202 can have a first length and the counterbore holes 502 can include a second length that is less than the first length. However, in some examples, the second length of the counterbore holes 502 can be equal to or greater than the first length. By including a counterbore hole 502 that includes a rounded interior hole edge 604, fuel that is injected into the cylinder 104 can disperse sooner than fuel injected through an injection orifice 202 that does not include a counterbore hole. Therefore, the counterbore hole 502 can improve atomization of the fuel that is injected into the cylinder 104 compared to other fuel injector nozzles.

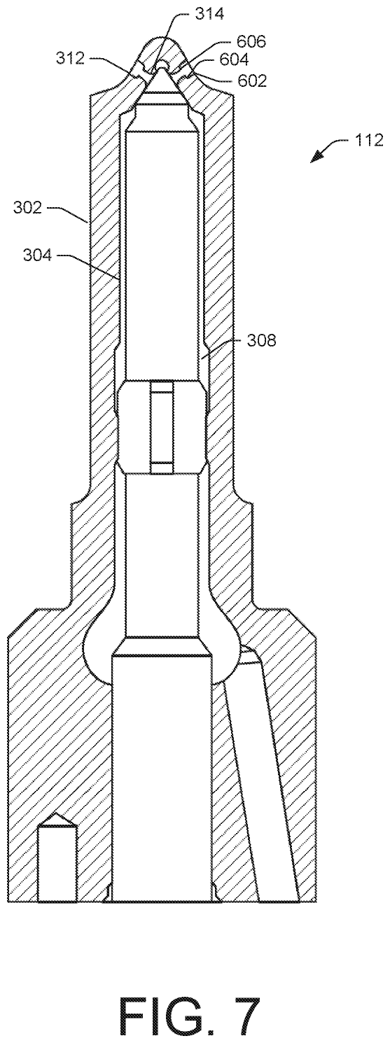

FIG. 7 is a cross-sectional view of the injector nozzle 112 taken along line D-D shown in FIG. 5. As shown in FIG. 7, the nozzle body 206 of the injector nozzle 112 includes an exterior surface 302 and an interior surface 304. The interior surface 304 of the nozzle body 206 defines the nozzle cavity 308. As shown in FIG. 7, the plurality of injection orifices 202 includes an exterior edge 312 on the exterior surface 302 of the nozzle body 206 and an interior edge 314 on the interior surface 304 of the nozzle body 206. The interior edge 314 of the plurality of injection orifices 202 can be rounded or chamfered. The interior edge 314 can be rounded or chamfered by flowing an abrasive-laden fluid through the plurality of injection orifices 202 in an AFM process (e.g., extrude honing process). Furthermore, the plurality of injection orifices 202 can include counterbore holes 502 as described and shown above with respect to FIGS. 5 and 6. As described above, the counterbore holes 502 include an exterior hole edge 602 on an exterior surface 302 of the nozzle body 206 and an interior hole edge 604 on an inside surface 606 of the counterbore hole 502. The interior hole edge 604 can be rounded, as shown in FIGS. 5-7. By rounding the interior hole edge 604, fuel is drawn out of an injection orifice quicker when compared with an interior hole edge that is a square edge.

As described previously, the counterbore holes 502 can be formed by an EDM process. In some examples, during the EDM process, an injection orifice 202 is chased with a wire (such as a tungsten wire) to create the counterbore hole 502. Typical EDM processes chase a hole the entire length of the counterbore to create a square interior edge. However, the counterbore holes 502 described herein are formed by chasing the injection orifice to approximately half of the desired length of the counterbore hole 502 and allowing water to pass around a deformed face of the wire in order to create the rounded interior hole edge 604. Thus, the counterbore hole 502 is chased to a desired length and the counterbore hole 502 includes a rounded interior hole edge 604. In some examples, each of the plurality of injection orifices 202 can include counterbore holes 502. Alternatively, select ones (and less than all) of the plurality of injection orifices 202 can include counterbore holes 502. As described above, the injector nozzle 112 can include one or more first injection orifices 202(1) having a first diameter that include counterbore holes 502 and/or one or more second injection orifices 202(2) having a second diameter that include counterbore holes 502.

### Conclusion

While the foregoing describes specific examples, it is to be understood that the scope of the claims is not limited to any of these specific examples. Since other modifications and changes varied to fit particular operating requirements and environments will be apparent to those skilled in the art, the claims should not be considered limited to the example chosen for purposes of disclosure, and cover all changes and modifications which do not constitute departures from the spirit and scope of this application.

Although the application describes specific structural features and/or methodological acts, it is to be understood that the claims are not necessarily limited to the specific features or acts described. Rather, the specific features and acts are merely illustrative of one or more examples that fall within the scope of the claims. Moreover, unless explicitly stated otherwise, any of the examples set forth herein are combinable.

What is claimed is:

1. A fuel injector nozzle comprising:
a nozzle body having a nozzle cavity and a nozzle tip defining an end of the nozzle body;
one or more first injection orifices having a first diameter, the one or more first injection orifices being located a first distance from the end of the nozzle body and connecting the nozzle cavity to a combustion chamber of an engine; and
one or more second injection orifices having a second diameter that is different than the first diameter, the one or more second injection orifices being located a second distance from the end of the nozzle body and connecting the nozzle cavity to the combustion chamber of the engine.

2. The fuel injector nozzle of claim 1, wherein the second diameter is less than the first diameter.

3. The fuel injector nozzle of claim 1, wherein the second distance is less than the first distance.

4. The fuel injector nozzle of claim 1, wherein the one or more first injection orifices include an exterior edge on an outside surface of the nozzle body and an interior edge on an inside surface of the nozzle body, wherein the interior edge is chamfered or rounded.

5. The fuel injector nozzle of claim 1, wherein the one or more second injection orifices include an exterior edge on an outside of the nozzle body and an interior edge on an inside of the nozzle body, wherein the interior edge is chamfered or rounded.

6. The fuel injector nozzle of claim 1, wherein the second diameter is approximately half of the first diameter.

7. The fuel injector nozzle of claim 1, wherein a length of the nozzle body extends in a vertical direction and the one or more second injection orifices are offset from the one or more first injection orifices in a horizontal direction.

8. The fuel injector nozzle of claim 1, wherein the second diameter is approximately half of the first diameter.

9. A fuel injector nozzle comprising:
a nozzle body including a nozzle cavity and a nozzle tip defining an end of the nozzle body; and
one or more injection orifices having a first diameter, the one or more injection orifices connecting the nozzle cavity to a combustion chamber of an engine, wherein at least one injection orifice of the one or more injection orifices includes a counterbore hole.

10. The fuel injector nozzle of claim 9, wherein the at least one injection orifice has a first diameter and the counterbore hole has a second diameter.

11. The fuel injector nozzle of claim 10, wherein the first diameter is approximately half of the second diameter.

12. The fuel injector nozzle of claim 9, wherein the at least one injection orifice has a first length and the counterbore hole has a second length that is less than the first length.

13. The fuel injector nozzle of claim 9, wherein the one or more injection orifices include an exterior edge on an outside of the nozzle body and an interior edge on an inside of the nozzle body, wherein the interior edge of each of the one or more injection orifices is chamfered or rounded.

14. The fuel injector nozzle of claim 13, wherein the interior edge is chamfered or rounded by flowing an abrasive-laden fluid through the one or more injection orifices.

15. The fuel injector nozzle of claim 9, wherein the counterbore hole includes an exterior hole edge on an outside surface of the nozzle body and an interior hole edge on an inside surface of the counterbore hole, wherein the interior hole edge is rounded.

16. An apparatus operational to inject fuel into a combustion chamber of an engine, the apparatus comprising:
a nozzle body including:
a nozzle cavity defined by an interior surface of the nozzle body;
a nozzle tip that defines an end of the nozzle body; and
a plurality of injection orifices, wherein fuel flows through the nozzle cavity and out of the plurality of injection orifices into the combustion chamber of the engine, wherein the plurality of injection orifices includes:
one or more first injection orifices having a first diameter, the one or more injection orifices being located a first distance from the end of the nozzle body and connecting the nozzle cavity to the combustion chamber of the engine; and
one or more second injection orifices having a second diameter that is different than the first diameter, the one or more second injection orifices being located a second distance from the end of the nozzle body and connecting the nozzle cavity to the combustion chamber of the engine.

17. The apparatus of claim 16, wherein the plurality of injection orifices includes an exterior edge on an outside surface of the nozzle body and an interior edge on an inside surface of the nozzle body, wherein the interior edge of the plurality of injection orifices is rounded.

18. The apparatus of claim 16, wherein the second diameter is approximately half of the first diameter.

19. The apparatus of claim 16, wherein the second distance is less than the first distance.

20. The apparatus of claim 16, wherein a length of the nozzle body extends in a vertical direction and individual ones of the one or more second injection orifices are offset from individual ones of the one or more first injection orifices in a horizontal direction.
